(19) United States
(12) Patent Application Publication
(10) Pub. No.: US 2014/0245388 A1
(43) Pub. Date: Aug. 28, 2014

(54) AUTHENTICATION APPARATUS, METHOD FOR CONTROLLING AUTHENTICATION APPARATUS, COMMUNICATION APPARATUS, AUTHENTICATION SYSTEM, AND STORAGE MEDIUM IN WHICH CONTROL PROGRAM IS STORED

(71) Applicant: SHARP KABUSHIKI KAISHA, Osaka (JP)

(72) Inventor: Kazuyuki NAKO, Osaka (JP)

(73) Assignee: SHARP KABUSHIKI KAISHA, Osaka (JP)

(21) Appl. No.: 14/184,917

(22) Filed: Feb. 20, 2014

(30) Foreign Application Priority Data
Feb. 28, 2013 (JP) 2013-039820

(51) Int. Cl. H04L 29/06

(52) U.S. Cl. CPC H04L 63/08
USPC 726/3

(57) ABSTRACT

A family message board server includes a device authentication section which authenticates a television in a case where an access to a family message board is made via the television, identification information of the television, user identification information, and identification information of a smart phone are received via the smart phone, and it is determined that the user identification information and the identification information of the smart phone which have been received respectively match user identification information and identification information of the smart phone which have been associated with each other by a device registration section.

This Nonprovisional application claims priority under 35 U.S.C. §119(a) on Patent Application No. 2013-039820 filed in Japan on Feb. 28, 2013, the entire contents of which are hereby incorporated by reference.

### TECHNICAL FIELD

The present invention relates to an authentication apparatus etc. for authenticating a predetermined device via which a user uses a predetermined service.

### BACKGROUND ART

As so-called social networking services get prevalent, structures for authenticating devices which enable users to use the social networking services are getting more and more important. For example, Patent Literature 1 below discloses an authentication server which receives a session identifier and user authentication information including a user identifier for identifying a user, and authenticates a user based on the received user authentication information and the generated session identifier. Patent Literature 2 below discloses an authentication system which is usable via any terminal and does not suffer a security problem.

### CITATION LIST

### Patent Literatures

### [Patent Literature 1]

Japanese Patent Application Publication, Tokukai, No. 2009-237686 A (published on Oct. 15, 2009)

### [Patent Literature 2]

Japanese Patent Application Publication, Tokukai, No. 2007-108973 A (published on Apr. 26, 2007)

### SUMMARY OF INVENTION

### Technical Problem

Assume that only a user A is registered as an “administrator” of a social networking service (which means a user with a special authority to administrate the service, such as an authority to register a user allowed to participate in the service and an authority to register a device allowed to access the service) in a server by which the social networking service operates.

According to the conventional art described in Patent Literature 1 or 2 above, only the user A can cause, via a predetermined device used by the user A, the server to authenticate other devices. This is because normally only an administrator is allowed to make an operation of registering a new device in the social networking service so as to keep robustness of the security of the system. Consequently, not only the administrator bears all the burden of administrating the system, but also a user without an authority as an administrator cannot easily register a new device. The conventional art is not user-friendly in this regard.

The present invention was made in view of the foregoing problem. An object of the present invention is to provide an authentication apparatus etc. which allows a user without an authority as an administrator to register a new device accessible to a system while keeping robustness of the security of the system, thereby providing higher user-friendliness.

### Solution to Problem

In order to solve the foregoing problem, an authentication apparatus in accordance with one aspect of the present invention is an authentication apparatus for authenticating a predetermined device via which a user uses a predetermined service, said authentication apparatus including: registration means for registering a first communication apparatus in such a manner that user identification information capable of uniquely identifying the user is associated with first identification information capable of uniquely identifying the first communication apparatus; reception means for, in a case where an access to the predetermined service is made via a second communication apparatus after the registration means has registered the first communication apparatus, receiving from the first communication apparatus (i) second identification information capable of uniquely identifying the second communication apparatus, (ii) user identification information, and (iii) first identification information; determination means for determining whether the user identification information and the first identification information which have been received by the reception means respectively match the user identification information and the first identification information which have been associated with each other by the registration means; and authentication means for, in a case where the determination means determines that the user identification information and the first identification information which have been received by the reception means respectively match the user identification information and the first identification information which have been associated with each other by the registration means, authenticating the second communication apparatus which is identified by the second identification information received by the reception means, so as to enable the user to use the predetermined service via the second communication apparatus.

In order to solve the foregoing problem, a method for controlling an authentication apparatus in accordance with one aspect of the present invention is a method for controlling an authentication apparatus for authenticating a predetermined device via which a user uses a predetermined service, said method including the steps of: (a) registering a first communication apparatus in such a manner that user identification information capable of uniquely identifying the user is associated with first identification information capable of uniquely identifying the first communication apparatus; (b) in a case where an access to the predetermined service is made via a second communication apparatus after registration of the first communication apparatus in the step (a), receiving from the first communication apparatus (i) second identification information capable of uniquely identifying the second communication apparatus, (ii) user identification information, and (iii) first identification information; (c) determining whether the user identification information and the first identification information which have been received in the step (b) respectively match the user identification information and the first identification information which have been associated with each other in the step (a); and (d) in a case where the step (c) determines that the user identification information and the first identification information which have been received in the step (b) respectively match the user identification information and the first identification information which have been associated with each other in the step (a), authenticating the second communication apparatus which is identified by the second identification information received in the step (b), so as to enable the user to use the predetermined service via the second communication apparatus.

### Advantageous Effects of Invention

The authentication apparatus and the method for controlling the authentication apparatus, each in accordance with one aspect of the present invention, allow a user without an authority as an administrator to register a new device accessible to a system while keeping robustness of the security of the system. Therefore, the authentication apparatus and the method for controlling the authentication apparatus can provide higher user-friendliness.

### BRIEF DESCRIPTION OF DRAWINGS

FIG. 1 is a block diagram illustrating a main configuration of a family message board server in accordance with First Embodiment of the present invention.

FIG. 2 is a drawing schematically illustrating an outline of the family message board system in accordance with First Embodiment of the present invention.

FIG. 3 is a drawing schematically illustrating how a smart phone in accordance with First Embodiment of the present invention displays an example of communications between users and a household device on the family message board.

FIG. 4 illustrates tables showing examples of specific data formats. (a) of FIG. 4 is a user information table, (b) of FIG. 4 is an issued temporary key management table, and (c) of FIG. 4 is a permitted content table.

FIG. 5 illustrates tables showing examples of specific data formats. (a) of FIG. 5 is a user's content table, (b) of FIG. 5 is a content information table, and (c) of FIG. 5 is a received temporary key management table.

FIG. 6 is a drawing schematically illustrating an example of a screen displayed on a display of a television in S26 in a flowchart shown as an example in FIG. 8.

FIG. 7 is a flowchart showing an example of a first process executed by the family message board system.

FIG. 8 is a flowchart showing an example of a second process executed by the family message board system.

(a) of FIG. 9 is a drawing schematically illustrating an example of a screen displayed on a display of a television in S46 in a flowchart shown as an example in FIG. 10. (b) of FIG. 9 is a drawing schematically illustrating an example of a screen displayed on the display of the television in S47.

FIG. 10 is a flowchart showing another example of the second process executed by the family message board system.

### DESCRIPTION OF EMBODIMENTS

### First Embodiment

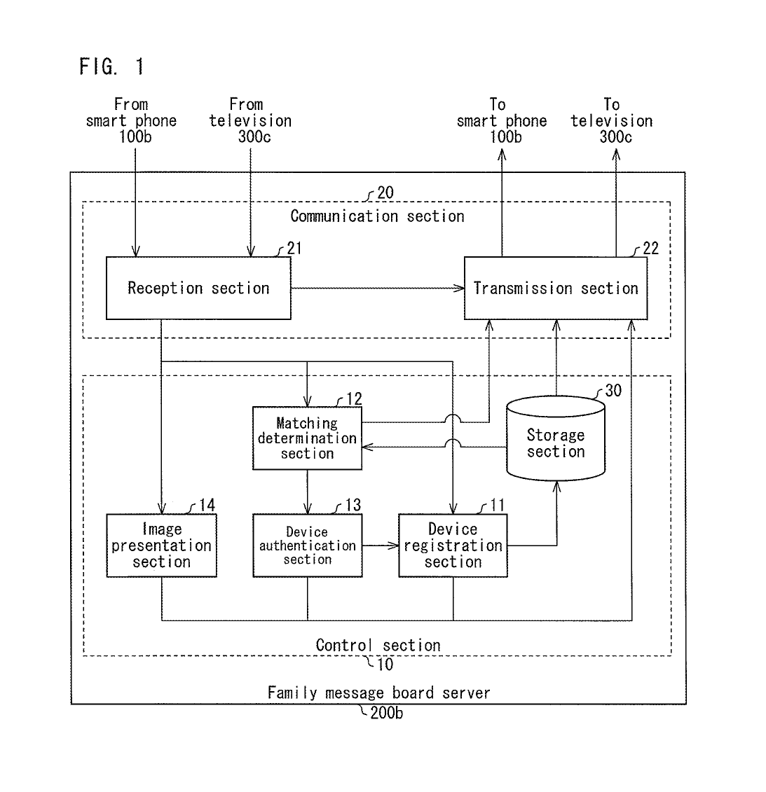

With reference to FIGS. 1 to 8, the following description will discuss First Embodiment of the present invention.

### [Outline of Family Message Board System 400]

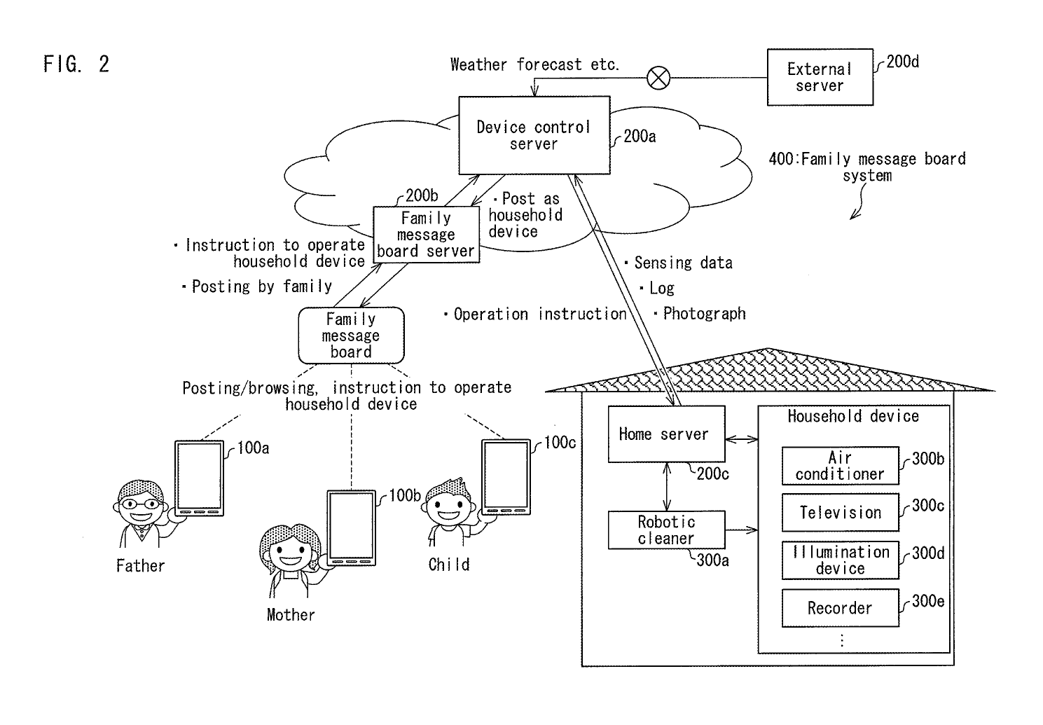

With reference to FIG. 2, a description will be provided below as to a family message board system 400. FIG. 2 is a drawing schematically illustrating an outline of the family message board system 400.

The family message board system (authentication system) 400 is a system which provides an electronic message board (family message board, so-called social networking service) which enables users registered in advance (father, mother, and child in the example of FIG. 2) to share information. The family message board system 400 includes smart phones 100a, 100b, and 100c, a device control server 200a, a family message board server 200b, a home server 200c, a robotic cleaner 300a, and a device or devices provided in a house (hereinafter, the robotic cleaner 300a and the device or devices provided in a house are collectively referred to as a “household device”).

In the family message board system 400, the household device posts a message on a family message board (predetermined service) according to a state of the household device, a content of a message posted by the user etc. Furthermore, the users can access the family message board and post or browse a message via their respective smart phones 100a, 100b, and 100c. Furthermore, the users can control an operation of the household device by giving an instruction to the household device via the family message board system 400.

The household device is communicably connected to the home server 200c (via a wire or wirelessly). FIG. 2 illustrates an example in which the devices provided in a house are an air conditioner 300b, a television 300c, an illumination device 300d, and a recorder 300e. However, the types and the number of the devices are not limited to them.

The device control server 200a receives messages and images posted via the smart phones 100a, 100b, and 100c, and transmits, to the home server 200c, instructions according to the posted messages and images, thereby controlling an operation of the household device.

The family message board server (authentication apparatus) 200b is a server for operating a family message board service. An agent who is a personified household device is installed in the family message board server 200b, and the agent posts, as a character who is a personified household device, a message etc. on the family message board, in accordance with a state of the household device, information obtained by the household device, posting of a user etc. This allows the user to have a pseudo-experience of communications with the household device on the family message board. Furthermore, the family message board server 200b executes all the processes related to the family message board, such as display of a screen of the family message board for the smart phones 100a, 100b, and 100c, and the management of posting.

The home server 200c comprehensively controls transmission/reception of information between the household device and the device control server 200a. Specifically, the home server 200c controls an operation of the household device in accordance with instruction information from the device control server 200a. Furthermore, the home server 200c transmits, to the device control server 200a, information obtained from the household device.

In FIG. 2, the device control server 200a and the family message board server 200b are provided separately. Alternatively, a single server may have functions of the device control server 200a and the family message board server 200b. Furthermore, in FIG. 2, the device control server 200a obtains external information from an external server 200d. Alternatively, the robotic cleaner 300a may obtain external information from the external server.

The smart phone 100a, the smart phone (first communication apparatus) 100b, and the smart phone 100c are each a portable information terminal via which a user browses the family message board, posts a message on the family message board, and gives an instruction to operate the household device. Note here that the same functions as those of the smart phones 100a, 100b, and 100c can be realized by mobile phones, personal computers, tablet terminals and the like. That is, the information terminal is not necessarily a smart phone as long as it is a device via which necessary information can be inputted/outputted.

The robotic cleaner 300a is a self-propelled robotic cleaner which autonomously cleans floors. The robotic cleaner 300a has not only a function for cleaning but also a function of storing operation logs, a function of detecting and outputting a remaining charge level, an image-capturing function, a voice-recognition function, an audio output function and the like. Furthermore, the robotic cleaner 300a also has a function of transmitting a control signal to a device provided in a house so as to operate the device.

The air conditioner 300b is a device for air-conditioning, such as cooling and heating. The air conditioner 300b includes a thermosensor, and transmits a detected room temperature to the home server 200c. The illumination device 300d is an illumination device including a light source such as an LED. The illumination device 300d can turn on/off light under control of the home server 200c. The television (second communication apparatus) 300c is a television receiver, and the recorder 300e is a device for recording a broadcasting program received by the television 300c. These devices can be operated under control of the home server 200c.

In the example illustrated in FIG. 2, the home server 200c transmits sensing data obtained by a sensor mounted on the household device, an operation log of the household device, and a photograph captured by the household device (photograph mainly captured by the robotic cleaner 300a). However, examples of the information to be transmitted are not limited to them. In a case where a comprehensive control by the home server 200c is not required, such as a case where there is no household device involved in the family message board, there may be employed a configuration in which the home server 200c is not provided and the robotic cleaner 300a transmits/receives information to/from the device control server 200a.

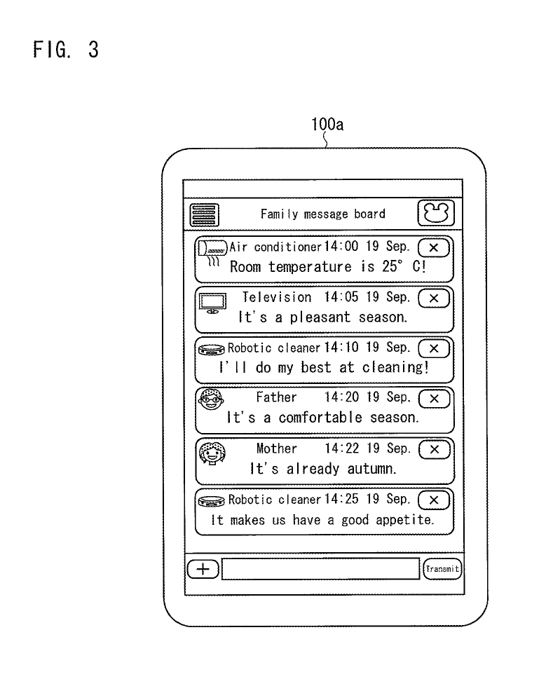

With reference to FIG. 3, the following description will discuss an outline of the family message board. FIG. 3 is a drawing schematically illustrating how the smart phone 100a displays an example of communications between the users and the household device on the family message board.

As illustrated in FIG. 3, the family message board system 400 allows the users (father and mother in the example of FIG. 3) and the household device (robotic cleaner 300a, air-conditioner 300b, and television 300c in the example of FIG. 3) to communicate with each other.

### [Outline of Family Message Board Server 200b]

With reference to FIG. 2, the following description will discuss a procedure in which the mother causes the family message board server 200b to authenticate the television 300c via the smart phone 100b used by the mother so as to make the family message board usable via the television 300c. Assume here that only the father is registered in the family message board server 200b as an “administrator” of the family message board (user with a special authority to administrate the family message board, such as an authority to register a user allowed to participate in the family message board and an authority to register a device allowed to access the family message board).

According to the conventional art, only the father can cause, via the smart phone used by the father, the server to authenticate the television. This is because normally only the administrator is allowed to make an operation of registering a new device in the family message board so as to keep robustness of the security of the system. Consequently, not only the administrator bears all the burden of administrating the system, but also a user (mother) without an authority as an administrator cannot easily register a new device. The conventional art is not user-friendly in this regard.

In contrast, the family message board system 400 including the family message board server 200b allows the mother without an authority as an administrator to register, in the family message board server, the television 300c as a device accessible to the family message board through the following procedure, while keeping robustness of the security of the system. That is,

(1) the family message board server 200b registers the smart phone 100b in such a manner that user identification information 2 capable of uniquely identifying the mother is associated with identification information 1b capable of uniquely identifying the smart phone 100b;
(2) after the registration of the smart phone 100b, when the mother attempts to access the family message board via the television 300c, the family message board server 200b receives from the smart phone 100b (i) identification information 1c capable of uniquely identifying the television 300c, (ii) user identification information 2, and (iii) identification information 1b;
(3) the family message board server 200b determines whether the user identification information 2 and the identification information 1b which have been received respectively match the user identification information 2 and the identification information 1b which have been associated with each other; and
(4) if the family message board server 200b determines that the user identification information 2 and the identification information 1b which have been received respectively match the user identification information 2 and the identification information 1b which have been associated with each other, the family message board server 200b authenticates the television 300c so as to enable the mother to use the family message board via the television 300c which is identified by the identification information 1c received from the smart phone 100b.

Consequently, with the family message board server 200b, the father does not have to bear all the burden of administrating the system, since the mother without an authority as an administrator can easily register a new device. Therefore, the family message board server 200b can provide higher user-friendliness.

### [Configuration of Family Message Board Server 200b]

With reference to FIG. 1, the following description will discuss a configuration of the family message board server 200b. FIG. 1 is a block diagram illustrating a main configuration of the family message board server 200b. For simplicity of the description, parts which are not directly related to the present embodiment (e.g. a part which receives a user's input via a keyboard etc.) are omitted in the explanation of the configuration and the block diagram. The family message board server 200b may include the omitted parts according to the actual condition under which the invention is carried out.

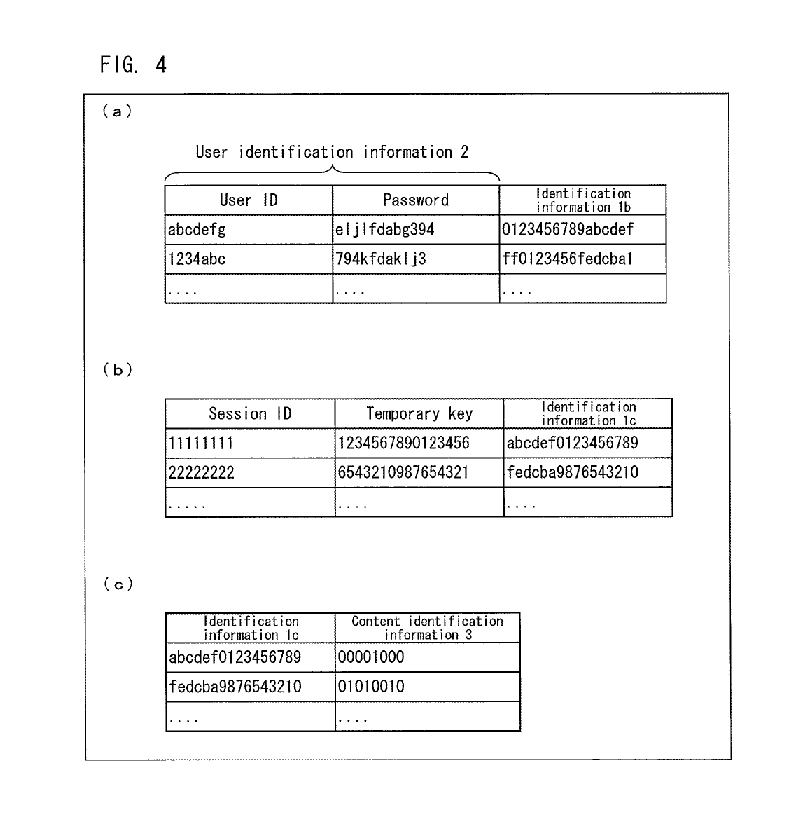

A control section 10 comprehensively controls functions of the family message board server 200b. For example, when the control section 10 receives from a matching determination section 12 a determination result 5a showing that the television 300c is not permitted (registered) as a device allowed to use a content requested via the television 300c, the control section 10 generates the identification information 1c and a temporary key (which is information such as a character string used only for a predetermined period in order to encrypt communication data), associates the generated temporary key with a session ID used in transmitting the request, and registers the identification information 1c and the temporary key associated with the session ID in an issued temporary key management table (see (b) of FIG. 4). Then, the control section 10 outputs the identification information 1c and the temporary key to an image presentation section 14. In a case where a session ID identical with the above session ID is already registered in the issued temporary key management table, the control section 10 does not carry out the process of generating and registering the identification information 1c and the temporary key. The control section 10 includes a device registration section 11, the matching determination section 12, a device authentication section 13, the image presentation section 14, and a storage section 30.

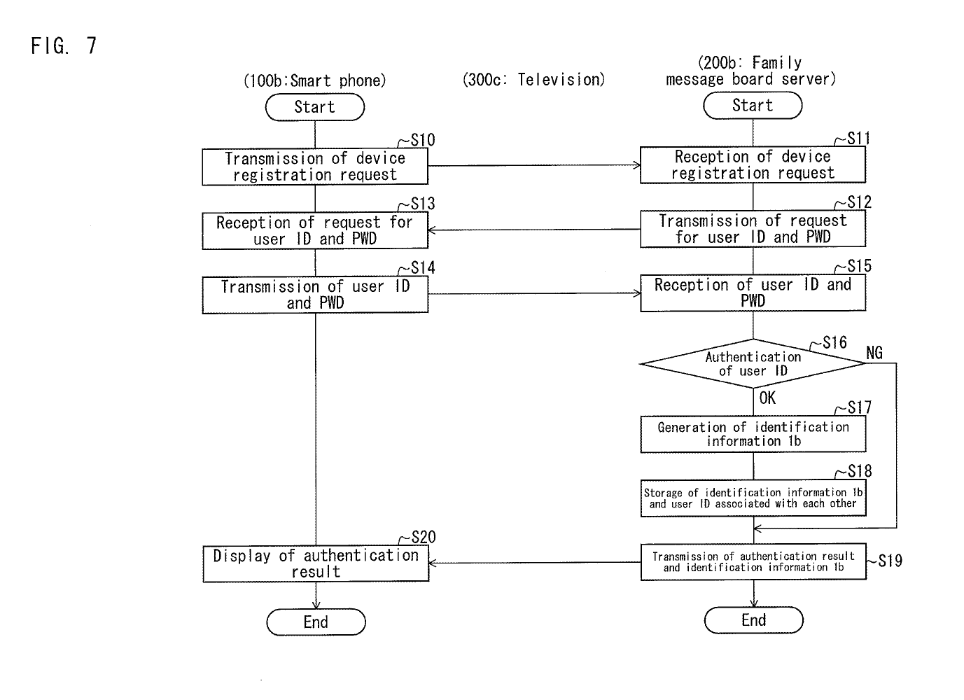

The device registration section (registration means) 11 registers the smart phone 100b by associating the user identification information 2 capable of uniquely identifying a user with the identification information 1b capable of uniquely identifying the smart phone 100b. Specifically, upon reception of the identification information 1b and the authenticated user identification information 2 from the device authentication section 13, the device registration section 11 adds the identification information 1b and the user identification information 2 to a user information table in such a manner that the identification information 1b is associated with the user identification information 2, causes the user information table to be stored in the storage section 30, and notifies a transmission section 22 of completion of the storage. The “user identification information” herein may be any information as long as it can uniquely identify a user, and may be, for example, a user ID and a password. The “authenticated user identification information” herein is user identification information which has been confirmed as that of a user allowed to use the family message board via the smart phone 100b (an example of a process for the confirmation will be described later with reference to FIG. 7).

Upon reception of the user identification information 2 from a reception section 21, the matching determination section 12 determines whether the user identification information 2 matches user identification information of a user (herein, mother) allowed to use the family message board via a predetermined device (herein, smart phone 100b). In a case where the user identification information 2 consists of a user ID and a password, the password includes a hash value, and the matching determination section 12 makes the aforementioned determination by calculating the hash value of the received password and comparing the hash value with that of the user identification information of the user allowed to use the family message board via a predetermined device. If determining that the user identification information 2 matches the user identification information of the user allowed to use the family message board via a predetermined device, the matching determination section 12 supplies a determination result 5b indicative of the matching to the device authentication section 13. If determining otherwise, the matching determination section 12 supplies a determination result 5b indicative of the unmatching to the transmission section 22.

Upon reception of the identification information 1c (which may be any information as long as it can uniquely identify a device, such as a serial number of the device) from the reception section 21, the matching determination section 12 refers to a permitted content table (whose specific data format will be described later with reference to (c) of FIG. 4) stored in the storage section 30 so as to determine whether a device (e.g. television 300c) identified by the identification information 1c is permitted as a device allowed to use a content (e.g. services such as a message board service as well as data, moving image, photograph, document etc. for displaying a screen in the example of FIG. 3) regarding the family message board which is requested via the device identified by the identification information 1c. If determining that the device identified by the identification information 1c is permitted as such a device, the matching determination section 12 supplies the identification information 1c and a determination result 5a indicative of the permission to the transmission section 22. If determining otherwise, or if the identification information 1c is not supplied from the reception section 21, the matching determination section 12 supplies a determination result 5a indicative of non-permission to the control section 10.

Furthermore, upon reception of the identification information 1c, the user identification information 2, and the identification information 1b from the reception section 21, the matching determination section (determination means) 12 determines whether the user identification information 2 and the identification information 1b thus received respectively match the user identification information 2 and the identification information 1b which have been associated with each other by the device registration section 11. Specifically, the matching determination section 12 refers to the user information table (whose specific data format will be described later with reference to (a) of FIG. 4) stored in the storage section 30 and compares the user identification information 2 and the identification information 1b which have been received by the reception section 21 with the user identification information 2 and the identification information 1b which are described in the user information table, thereby determining whether the user identification information 2 and the identification information 1b which have been received by the reception section 21 respectively match the user identification information 2 and the identification information 1b which are described in the user information table. The matching determination section 12 supplies the user identification information 2 and a determination result 5c indicative of the determination result to the device authentication section 13.

When the device authentication section 13 receives, from the matching determination section 12, the determination result 5b showing that the user identification information 2 received by the reception section 21 matches the user identification information 2 of the user allowed to use the family message board via the smart phone 100b, the device authentication section 13 generates the identification information 1b capable of uniquely identifying the smart phone 100b, and supplies the identification information 1b to the device registration section 11. Since the identification information 1b may be an ID unique to the smart phone 100b (e.g. serial number), the device authentication section 13 generates the identification information 1b by obtaining such an ID from the smart phone 100b.

Furthermore, when the device authentication section 13 receives, from the matching determination section 12, the user identification information 2 and the determination result 5c indicative of the matching, the device authentication section 13 supplies, to the transmission section 22, the user identification information 2 supplied from the matching determination section 12.

Furthermore, when the device authentication section (authentication means) 13 receives, from the reception section 21, content identification information 3 capable of uniquely identifying a content selected by the user, the device authentication section 13 authenticates the television 300c identified by the identification information 1c received by the reception section 21, so as to enable the user to use the family message board via the television 300c. Specifically, the device authentication section 13 refers to a received temporary key management table so as to obtain a temporary key corresponding to the current session ID. Next, the device authentication section 13 refers to the issued temporary key management table (whose data format will be described later with reference to (b) of FIG. 4) so as to obtain the identification information 1c associated with the temporary key. Lastly, the device authentication section 13 adds the identification information 1c and the content identification information 3 to the permitted content table in such a manner that the identification information 1c is associated with the content identification information 3, and causes the permitted content table to be stored in the storage section 30.

Upon reception of the identification information 1c and the temporary key, the image presentation section (presentation means) 14 generates an image obtained as a result of encoding of an authentication URL including the identification information 1c and the temporary key, and supplies the identification information 1c and the image to the transmission section 22. The “authentication URL” herein is information (Uniform Resource Locator) capable of uniquely identifying a web page which enables a user (herein, mother) identified by the user identification information 2 associated with the identification information 1b of a device (herein, smart phone 100b) registered by the device registration section 11 to enter the user identification information 2 for the purpose of confirmation of the user's attempt to cause the family message board server 200b to authenticate the television 300 via the device. The “authentication URL” is expressed as “https://xxxxxxxxxx/register?c=12345678” for example. The “image obtained as a result of encoding” above is information obtained by encoding (two-dimensionally encoding) the authentication URL including the identification information 1c and the temporary key so that the identification information 1c and the temporary key are changed into an image, and may be a two-dimensional barcode image (so-called “QR code (Registered Trademark)”) for example.

The communication section 20 communicates with an outside by means of predetermined communication hardware via a communication network according to a predetermined communication method. The communication section 20 is not limited in terms of a communication line, a communication method, a communication medium or the like as long as the communication section 20 has an essential function for realizing communications with an external device. The communication section 20 may be composed of a device such as an Ethernet (Registered Trademark) adaptor. The communication section 20 may use a communication method and a communication medium such as IEEE802.11 wireless communication and Bluetooth (Registered Trademark). The communication section 20 includes the reception section 21 and the transmission section 22.

Upon reception of a device registration request from the smart phone 100b, the reception section 21 notifies the transmission section 22 to transmit, to the smart phone 100b, a request for the smart phone 100b to transmit the user identification information 2. The “device registration request” herein is a request of a user (herein, mother) to register the smart phone 100b as a device via which the user can cause the family message board server 200b to authenticate the television 300c.

When the reception section 21 receives, from the smart phone 100b, the user identification information 2 of the user (herein, mother) so that the user can register the smart phone 100b as a device via which the user can cause the family message board server 200b to authenticate the television 300c, the reception section 21 supplies the user identification information 2 to the matching determination section 12.

Furthermore, when the reception section 21 receives, from the television 300c, a request for a content regarding the family message board and the identification information 1c, the reception section 21 supplies the identification information 1c to the matching determination section 12. The reception section 21 may receive the identification information 1c in the form of a cookie (information sent from a website and stored in a user's computer).

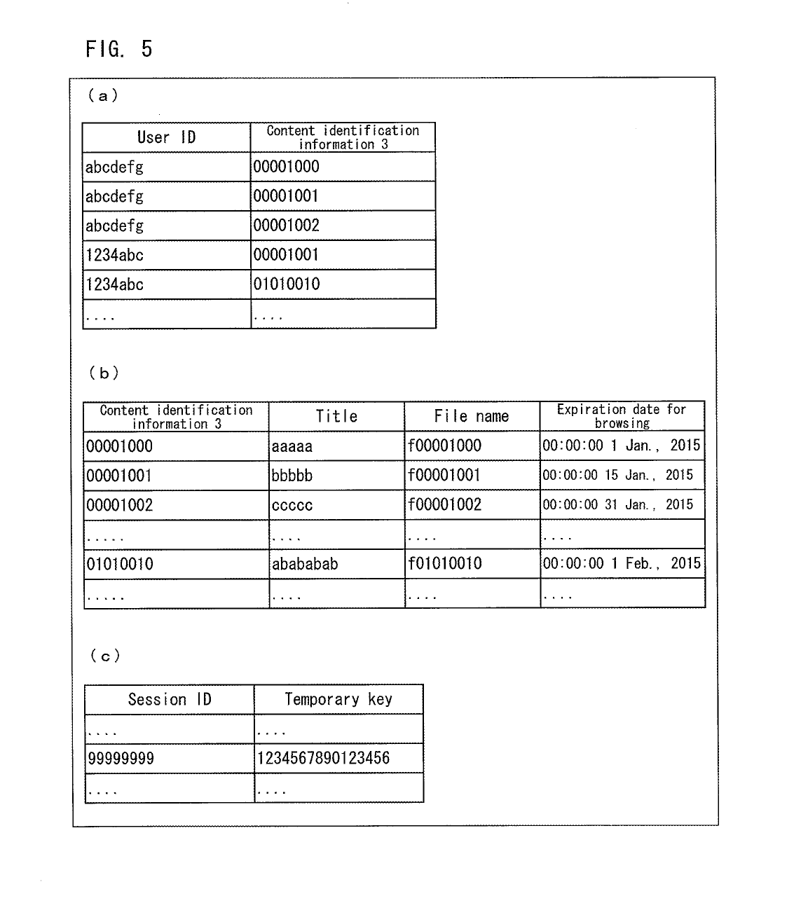

Furthermore, the reception section 21 receives an authentication request from the smart phone 100b. The “authentication request” herein is a request which is made detectable by the family message board server 200b (receivable by the reception section 21) when the smart phone 100b accesses the authentication URL. Upon reception of the authentication request, the reception section 21 associates the temporary key included in the authentication URL with the session ID of the authentication request, adds the temporary key and the session ID which are associated with each other to the received temporary key management table (whose specific data format will be described later with reference to (c) of FIG. 5), and causes the received temporary key management table to be stored in the storage section 30. At the same time, the reception section 21 notifies the transmission section 22 to transmit to the smart phone 100b a request which requests the smart phone 100b to transmit the user identification information 2.

In a case where a user attempts to access the family message board via the television 300c after the device registration section 11 has registered the smart phone 100b, the reception section (reception means) 21 receives, from the smart phone 100b, the identification information 1c capable of uniquely identifying the television 300c, the user identification information 2, and the identification information 1b, and supplies these information to the matching determination section 12. Specifically, the reception section 21 associates the temporary key included in the authentication URL with the session ID, adds the associated data to the received temporary key management table, and causes the received temporary key management table to be stored in the storage section 30. Here, the reception section 21 can be considered as receiving the identification information 1c, since the temporary key received by the reception section 21 can uniquely identify the identification information 1c. Furthermore, the reception section 21 receives, from the smart phone 100b, (i) the user identification information 2 which is a reply from the smart phone 100b in response to the request for the user identification information 2 and (ii) the identification information 1b. The reception section 21 may receive the identification information 1b in the form of a cookie.

Furthermore, the reception section (obtaining means) 21 obtains, from the smart phone 100b, the content identification information 3 capable of uniquely identifying a content selected by the user out of contents listed as list information (presentation information) 4 showing the contents provided by a service of the family message board. Then, the reception section 21 supplies the content identification information 3 to the device authentication section 13.

When the transmission section 22 is notified by the device registration section 11 of completion of storage of the user information table in the storage section, the transmission section 22 transmits, to the smart phone 100b, (i) information indicative of registration of the smart phone 100b as a device via which the user can cause the family message board server 200b to authenticate the television 300c and (ii) the identification information 1b generated by the device authentication section 13.

Furthermore, when the transmission section 22 receives, from the reception section 21, an instruction to transmit to the smart phone 100b an instruction to request the smart phone 100b to transmit the user identification information 2, the transmission section 22 requests the smart phone 100b to transmit the user identification information 2.

Furthermore, when the transmission section 22 receives from the matching determination section 12 the determination result 5b indicative of unmatching, the transmission section 22 transmits to the smart phone 100b information indicative of failure of the authentication. Furthermore, when the transmission section 22 receives from the image presentation section 14 an image obtained as a result of encoding of the authentication URL including the identification information 1c and the temporary key, the transmission section 22 transmits the identification information 1c and the image to the television 300c.

Furthermore, when the transmission section 22 receives, from the matching determination section 12, the identification information 1c and the determination result 5a indicative of permission, the transmission section 22 refers to the permitted content table and transmits, to the television 300c, a content identified by the content identification information 3 associated with the identification information 1c.

When the transmission section (transmission means) 22 receives the user identification information 2 from the device authentication section 13, the transmission section 22 refers to a user's content table (whose specific data format will be described later with reference to (a) of FIG. 5) and transmits, to the smart phone 100b, the list information 4 (list of content IDs corresponding to the user identification information 2) showing a list of contents which are provided by the family message board and are to be browsable by the user via the television 300c. Herein, the transmission section 22 may refer to a content information table (whose specific data format will be described with reference to (b) of FIG. 5) and transmit information regarding a tile of the content, together with the list information 4.

The storage section 30 is a storage device in which the user information table ((a) of FIG. 4), the issued temporary key management table ((b) of FIG. 4), the permitted content table ((c) of FIG. 4), the user's content table ((a) of FIG. 5), the content information table ((b) of FIG. 5), the received temporary key management table ((c) of FIG. 5), and contents regarding the family message board can be stored. The storage section 30 may be composed of, for example, a hard disc, a semiconductor memory, or a DVD.

### [Examples of Data Formats]

With reference to FIGS. 4 and 5, the following description will discuss examples of data formats used for the aforementioned tables and contents. FIG. 4 illustrates tables showing examples of specific data formats. (a) of FIG. 4 is the user information table, (b) of FIG. 4 is the issued temporary key management table, and (c) of FIG. 4 is the permitted content table. FIG. 5 illustrates tables showing examples of specific data formats. (a) of FIG. 5 is the user's content table, (b) of FIG. 5 is the content information table, and (c) of FIG. 5 is the received temporary key management table.

As illustrated in (a)-(c) of FIG. 4 and (a)-(c) of FIG. 5, the family message board server 200b manages the identification information 1b, the identification information 1c, the user identification information 2, the content identification information 3, and various information (e.g. temporary key, session ID) accompanying these information, and causes such information to be stored in the storage section 30.

### [Process Executed by Family Message Board Server 200b]

With reference to FIG. 7, the following description will discuss a flow of a first process executed by the family message board server 200b. FIG. 7 is a flowchart showing an example of the first process executed by the family message board system 400 (first process executed by the smart phone 100b, the television 300c, and the family message board server 200b).

Initially, the smart phone 100b transmits a device registration request to the family message board server 200b (step 10; hereinafter, each step is abbreviated as “S”, e.g. “step 10” as “S10”). When the reception section 21 receives the device registration request (S11), the transmission section 22 requests the smart phone 100b to transmit the user identification information 2 (e.g. user ID and password) (S12). The smart phone 100b receives the request to transmit the user identification information 2 (S13), and transmits the user identification information 2 entered by a user to the family message board server 200b (S14).

When the reception section 21 receives the user identification information 2 (S15), the matching determination section 12 refers to the user information table, and compares the user identification information 2 with user identification information of a user allowed to use the family message board via the smart phone 100b, thereby determining whether the user identification information 2 matches the user identification information of such a user (S16). If the matching determination section 12 determines that the user identification information 2 does not match the user identification information of such a user (NG in S16), the transmission section 22 transmits information indicative of failure of authentication to the smart phone 100b (S19).

If the matching determination section 12 determines that the user identification information 2 matches the user identification information of such a user (OK in S16), the device authentication section 13 generates the identification information 1b (S17). Then, the device registration section 11 adds the identification information 1b and the user identification information 2 to the user information table in such a manner that the identification information 1b is associated with the user identification information 2, and causes the user information table to be stored in the storage section 30 (S18, registration step). The transmission section 22 transmits, to the smart phone 100b, (i) information indicative of the registration of the smart phone 100b as a device via which the user can cause the family message board server 200b to authenticate the television 300c and (ii) a request to set, as a cookie, the identification information 1b generated by the device authentication section 13 (S19). The smart phone 100b receives the information (result of authentication) from the family message board server 200b, and displays the information on its display (S20).

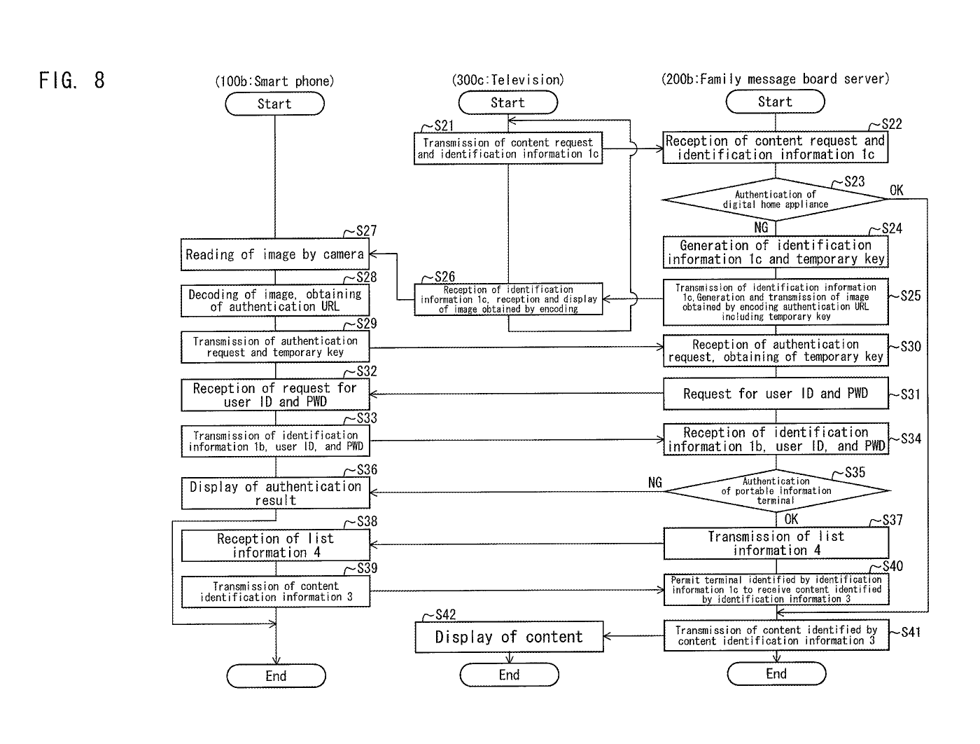

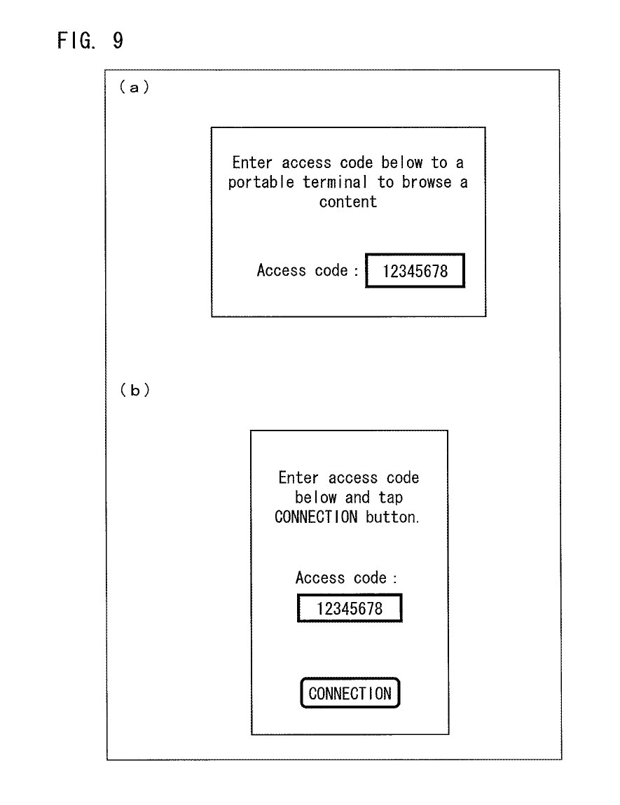

With reference to FIG. 8, the following description will discuss a flow of a second process executed by the family message board server 200b. FIG. 8 is a flowchart showing an example of the second process executed by the family message board system 400 (second process executed by the smart phone 100b, the television 300c, and the family message board server 200b).

Initially, the television 300c transmits, to the family message board server 200b, a request for a content regarding the family message board and the identification information 1c in the form of a cookie capable of uniquely identifying the television 300c (S21). In a case where a cookie does not exist, the television 300c does not transmit the identification information 1c. In such a case, the request for a content is transmitted without the content identification information 3. When the reception section 21 receives at least one of the request and the identification information 1c from the television 300c (S22), the matching determination section 12 determines whether the television 300c is permitted as a device allowed to use the requested content (S23). Specifically, the matching determination section 12 determines whether the identification information 1c is registered in the permitted content table or not.

If the matching determination section 12 determines that the television 300c is permitted (if the identification information 1c is registered in the permitted content table, OK in S23), the transmission section 22 refers to the permitted content table and transmits, to the television 300c, the content identified by the content identification information 3 associated with the identification information 1c (S41). If the matching determination section 12 determines that the television 300c is not permitted (if the identification information 1c is not registered in the permitted content table or if the identification information 1c is not received from the television 300c, NG in S23), the control section 10 generates the identification information 1c and a temporary key, associates the generated temporary key with a session ID used for communication of the request, and registers the identification information 1c and the temporary key associated with the session ID in the issued temporary key management table (S24). The image presentation section 14 generates an image obtained as a result of encoding of an authentication URL including the identification information 1c and the temporary key, and the transmission section 22 transmits the identification information 1c and the image to the television 300c (S25).

When receiving the image and the identification information 1c, the television 300c sets the identification information 1c as a cookie, and displays the image on its display (S26). In S26, when the user makes an operation of reading the image again, or when a predetermined period of time has passed without any operation, the process goes back to S21.

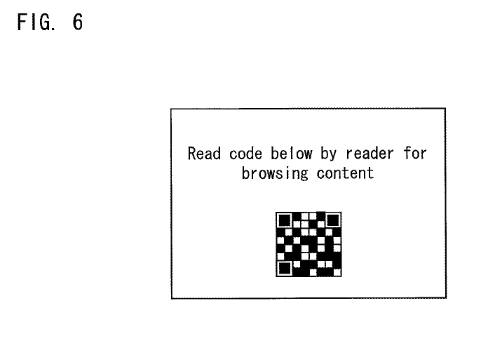

FIG. 6 is a drawing schematically illustrating an example of an image which the television 300c displays on its display in S26. As illustrated in FIG. 6, the television 300c displays on its display the image obtained as a result of encoding of the authentication URL including the temporary key. The user reads the image illustrated in FIG. 6 by using a camera mounted on the smart phone 100b (S27), and the smart phone 100b decodes the image (e.g., by a predetermined application such as a QR code (Registered Trademark) reader application) and obtains the authentication URL included in the image (S28). Then, the smart phone 100b accesses the authentication URL so as to transmit an authentication request and the temporary key included in the authentication URL to the family message board server 200b (S29).

The reception section 21 receives the authentication request from the smart phone 100b, associates the temporary key included in the authentication URL with a session ID used in communication of the authentication request, adds the associated data to the received temporary key management table, and causes the received temporary key management table to be stored in the storage section 30 (S30, reception step). Here, the reception section 21 can be considered as receiving the identification information 1c in S30, since the identification information 1c can be uniquely identified from the temporary key received by the reception section 21 as will be described in the explanation on S40. The transmission section 22 requests the smart phone 100b to transmit the user identification information 2 (S31).

The smart phone 100b receives the request to transmit the user identification information 2 (S32), and transmits the user identification information 2 entered by the user and the identification information 1b in the form of a cookie to the family message board server 200b (S33). The reception section 21 receives the user identification information 2 and the identification information 1b from the smart phone 100b (S34, reception step), and supplies the user identification information 2 and the identification information 1b to the matching determination section 12. The matching determination section 12 determines whether the user identification information 2 and the identification information 1b respectively match the user identification information 2 and the identification information 1b which have been associated with each other by the device registration section 11 (S35, determination step).

If the matching determination section 12 determines that the user identification information 2 and the identification information 1b do not respectively match the user identification information 2 and the identification information 1b which have been associated with each other by the device registration section 11 (NG in S35), the transmission section 22 transmits information indicative of failure of authentication of the television 300c to the smart phone 100b, and the smart phone 100b receives and displays the information (S36). If the matching determination section 12 determines that the user identification information 2 and the identification information 1b respectively match the user identification information 2 and the identification information 1b which have been associated with each other by the device registration section 11 (OK in S35), the transmission section 22 transmits the list information 4 to the smart phone 100b (S37). In this process, the transmission section 22 refers to the content information table, and transmits information regarding a title of the content (title information) at the same time as the transmission of the list information 4. The smart phone 100b receives the list information 4 and the title information (S38), and transmits the content identification information 3 indicative of the content selected by the user to the family message board server 200b (S39).

When the reception section 21 receives the content identification information 3, the device authentication section 13 authenticates the television 300c so as to enable the user to use the family message board via the television 300c (S40, authentication step). Specifically, the device authentication section 13 refers to the received temporary key management table so as to obtain the temporary key associated with the current session ID. Furthermore, the device authentication section 13 refers to the issued temporary key management table so as to obtain the identification information 1c associated with the temporary key. Furthermore, the device authentication section 13 associates the content identification information 3 with the identification information 1c, and registers the content identification information 3 and the identification information 1c in the permitted content table. The transmission section 22 refers to the permitted content table, and transmits, to the television 300c, a content identified by the content identification information 3 associated with the identification information 1c (S41). The television 300c displays on its display the content transmitted from the family message board server 200b (S42).

### [Effect Yielded by Family Message Board Server 200b]

With the family message board server 200b, a single user (e.g. father) does not have to bear all the burden of administrating the system, and other user (e.g. mother) without an authority as an administrator can easily register a new device. Therefore, the family message board server 200b can provide higher user-friendliness.

Furthermore, by the smart phone 100b reading and decoding an image (e.g. QR code (Registered Trademark)) displayed on the television 300c, a user (e.g. mother) who wants to cause the family message board server 200b to authenticate the television 300c is not required to enter the identification information 1c, the user identification information 2, and the identification information 1b (e.g. via a predetermined input interface) (that is, the user is not required to make a troublesome operation). Therefore, the family message board server 200b can provide further higher user-friendliness.

Furthermore, the television 300c is only required to request the authentication URL for a content. Therefore, without the need to prepare a destination address of a content, parameter etc. with respect to each user, the family message board server 200b can notify the television 300c of a destination address of a content via multicasting services such as e-mail, banner advertising, a portal site, a blog, and news.

### Second Embodiment

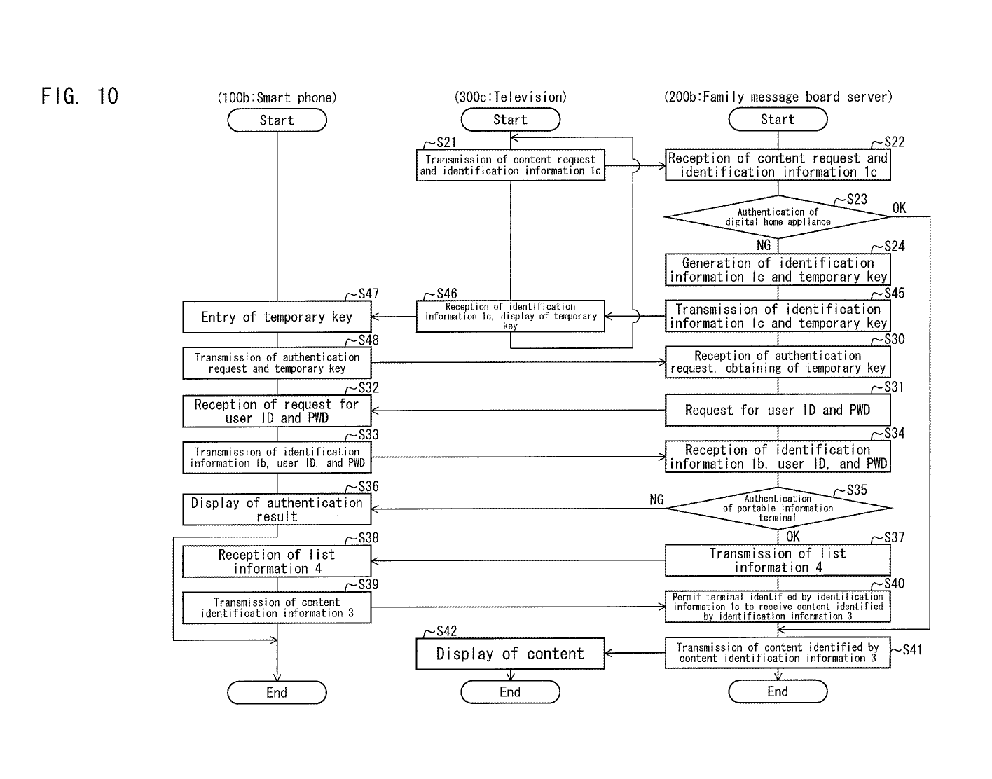

With reference to FIGS. 9 and 10, the following description will discuss Second Embodiment of the present invention. FIG. 10 is a flowchart showing another example of the second process executed by the family message board system 400 (second process executed by the smart phone 100b, the television 300c, and the family message board server 200b). In the present embodiment, the family message board server 200b further includes a temporary key presentation section 15, so that the second process includes S45-S48 instead of S25-S29, which are included in the process example described with reference to FIG. 8 (except for this difference, the second process in Second Embodiment is the same as the second process in First Embodiment).

The temporary key presentation section 15 generates a temporary key as character information, and the transmission section 22 transmits the temporary key to the television 300c (S45). In this process, in order to set the identification information 1c as a cookie in the television 300c, the transmission section 22 transmits the identification information 1c (as a cookie setting request) together with the temporary key. The television 300c sets the received identification information 1c as a cookie, and displays on its display the temporary key as characters (S46). In S46, if the user makes an operation of reading the temporary key again or if a predetermined period of time has passed without any operation, the process goes back to S21. If the user enters the temporary key displayed on the display into the smart phone 100b via a predetermined input interface (S47), the smart phone 100b adds information regarding the inputted temporary key as a parameter to the authentication URL, and accesses the authentication URL (S48).

(a) of FIG. 9 is a drawing schematically illustrating an example of a screen displayed on the display of the television 300c in S46. (b) of FIG. 9 is a drawing schematically illustrating an example of a screen displayed on the display of the television 300c in S47.

As illustrated in (a) of FIG. 9, when the television 300c displays on its display the temporary key (access code), the user enters the access code via an input interface illustrated in (b) of FIG. 9 with use of the smart phone 100b, and taps a “connection” button, thereby transmitting an authentication request to the family message board server 200b (the smart phone 100b adds information regarding the inputted temporary key as a parameter to the authentication URL, and accesses the authentication URL). This allows the user to cause the family message board server 200b to authenticate the television 300c without using a predetermined application such as a QR code (Registered Trademark) reader.

### Third Embodiment

Each block of the family message board server 200b may be realized by a logic circuit (hardware) provided in an integrated circuit (IC chip etc.) or by software as executed by a CPU (Central Processing Unit). In the latter case, the family message board server 200b includes: a CPU that executes instructions of a program which is software realizing the foregoing functions; a ROM (Read Only Memory) or a storage device (each referred to as “storage medium”) that stores the program and various data in such a form that they are readable by a computer (or CPU); and an RAM (Random Access Memory) that develops the program in executable form. The object of the present invention can be achieved by a computer (or CPU) reading and executing the program stored in the storage medium. The storage medium may be a “non-transitory tangible medium”, such as tapes, discs, cards, semiconductor memories, and programmable logic circuits. The program may be supplied to or made available to the computer via any transmission medium (communication network, broadcast wave etc.) which enables transmission of the program. Note that the present invention can be also implemented by the program in the form of a data signal embedded in a carrier wave which is embodied by electronic transmission.

### SUMMARY

An authentication apparatus in accordance with first aspect of the present invention is an authentication apparatus (family message board server 200b) for authenticating a predetermined device via which a user uses a predetermined service (family message board), said authentication apparatus including: registration means (device registration section 11) for registering a first communication apparatus (smart phone 100b) in such a manner that user identification information (user identification information 2) capable of uniquely identifying the user is associated with first identification information (identification information 1b) capable of uniquely identifying the first communication apparatus; reception means (reception section 21) for, in a case where an access to the predetermined service is made via a second communication apparatus (television 300c) after the registration means has registered the first communication apparatus, receiving from the first communication apparatus (i) second identification information (identification information 1c) capable of uniquely identifying the second communication apparatus, (ii) user identification information, and (iii) first identification information; determination means (matching determination section 12) for determining whether the user identification information and the first identification information which have been received by the reception means respectively match the user identification information and the first identification information which have been associated with each other by the registration means; and authentication means (device authentication section 13) for, in a case where the determination means determines that the user identification information and the first identification information which have been received by the reception means respectively match the user identification information and the first identification information which have been associated with each other by the registration means, authenticating the second communication apparatus which is identified by the second identification information received by the reception means, so as to enable the user to use the predetermined service via the second communication apparatus.

A method for controlling an authentication apparatus in accordance with first aspect of the present invention is a method for controlling an authentication apparatus for authenticating a predetermined device via which a user uses a predetermined service, said method including the steps of: (a) registering (S18) a first communication apparatus in such a manner that user identification information capable of uniquely identifying the user is associated with first identification information capable of uniquely identifying the first communication apparatus; (b) in a case where an access to the predetermined service is made via a second communication apparatus after registration of the first communication apparatus in the step (a), receiving (S30, S34) from the first communication apparatus (i) second identification information capable of uniquely identifying the second communication apparatus, (ii) user identification information, and (iii) first identification information; (c) determining (S35) whether the user identification information and the first identification information which have been received in the step (b) respectively match the user identification information and the first identification information which have been associated with each other in the step (a); and (d) in a case where the step (c) determines that the user identification information and the first identification information which have been received in the step (b) respectively match the user identification information and the first identification information which have been associated with each other in the step (a), authenticating (S40) the second communication apparatus which is identified by the second identification information received in the step (b), so as to enable the user to use the predetermined service via the second communication apparatus.

As described above, according to the conventional art, only a user (administrator) with a special authority as an administrator of a system can cause, via a predetermined device used by the user, a server by which a predetermined service operates to authenticate other devices. This is because normally only the administrator is allowed to make an operation of registering a new device in the predetermined service so as to keep robustness of the security of the system. Consequently, not only the administrator bears all the burden of administrating the system, but also a user without an authority as an administrator cannot easily register a new device. The conventional art is not user-friendly in this regard.

On the other hand, the authentication apparatus and the method for controlling the authentication apparatus allow a user without an authority as an administrator to register the second communication apparatus as a device accessible to the predetermined system. That is, the authentication apparatus and the method for controlling the authentication apparatus allow a user without an authority as an administrator to easily register a new device, without intensively imposing on the administrator the burden of administering the system. Therefore, the authentication apparatus and the method for controlling the authentication apparatus can provide higher user-friendliness.

The authentication apparatus in accordance with second aspect of the present invention may be an arrangement of the authentication apparatus in accordance with the first aspect so as to further include presentation means (image presentation section 14) for transmitting an image obtained as a result of encoding of the second identification information to the second communication apparatus so as to cause the second communication apparatus to present the image in such a manner as to be readable by the first communication apparatus, the reception means receiving from the first communication apparatus (i) the second identification information obtained as a result of decoding of the image, (ii) the user identification information, and (iii) the first identification information.

As described above, by the first communication apparatus reading the image displayed on the second communication apparatus and decoding the image, a user who wants to cause the authentication apparatus to authenticate the second communication apparatus is not required to enter the second identification information, the user identification information, and the first identification information (via, for example, a predetermined input interface). Therefore, the authentication apparatus can provide further higher user-friendliness.

An authentication apparatus in accordance with third aspect of the present invention may be an arrangement of the authentication apparatus in accordance with the first aspect or the second aspect of the present invention so as to further include: transmission means (transmission section 22) for transmitting, to the first communication apparatus, presentation information (list information 4) indicative of one or more contents which are provided by the predetermined service and which are to be browsable by the user via the second communication apparatus; and obtaining means (reception section 21) for obtaining, from the first communication apparatus, content identification information (content identification information 3) capable of uniquely identifying a content selected by the user out of said one or more contents indicated by the presentation information, in a case where the determination means determines that the user identification information and the first identification information which have been received by the reception means respectively match the user identification information and the first identification information which have been associated with each other by the registration means, the authentication means authenticating the second communication apparatus so as to enable the user to browse, via the second communication apparatus, the content identified by the content identification information obtained by the obtaining means.

That is, the authentication apparatus can authenticate the second communication apparatus so that the user can browse via the second communication apparatus only the content selected by the user. Consequently, the authentication apparatus can provide further higher user-friendliness.

A communication apparatus being a first communication apparatus in accordance with fourth aspect of the present invention may be registered in an authentication apparatus in accordance with any one of the first aspect to the third aspect of the present invention so as to serve as a device via which a second communication apparatus is able to be authenticated by the authentication apparatus. Therefore, the first communication apparatus yields an effect similar to that of the authentication apparatus.

A communication apparatus being a second communication apparatus in accordance with fifth aspect of the present invention may be authenticated by an authentication apparatus in accordance with any one of the first aspect to the third aspect of the present invention via a first communication apparatus in accordance with the fourth aspect of the present invention. Therefore, the second communication apparatus yields an effect similar to that of the authentication apparatus.

An authentication system in accordance with sixth aspect of the present invention may include: an authentication apparatus in accordance with any one of the first aspect to the third aspect of the present invention; a first communication apparatus in accordance with the fourth aspect of the present invention; and a second communication apparatus in accordance with the fifth aspect of the present invention. Therefore, the authentication system yields an effect similar to that of the authentication apparatus.

The authentication apparatus may be realized by a computer. In this case, the present invention also encompasses (i) a control program for enabling a computer to realize the authentication apparatus by causing the computer to function as each means of the authentication apparatus, and (ii) a computer-readable storage medium in which the control program is stored. Furthermore, the present invention is not limited to the description of the embodiments above, but may be altered by a skilled person within the scope of the claims. An embodiment based on a proper combination of technical means disclosed in different embodiments is encompassed in the technical scope of the present invention. Furthermore, a new technical feature can be provided by combining technical means disclosed in individual embodiments.

### INDUSTRIAL APPLICABILITY

The present invention is widely applicable to an authentication apparatus etc. which authenticates a predetermined device (e.g. smart phone) as a device via which a user can use a predetermined service (e.g. social networking service).

### REFERENCE SIGNS LIST

1b Identification information (first identification information)
1c Identification information (second identification information)
2 User Identification information (user identification information)
3 Content identification information (content identification information)
4 List information (presentation information)
11 Device registration section (registration means)
12 Matching determination section (determination means)
13 Device authentication section (authentication means)
14 Image presentation section (presentation means)
21 Reception section (reception means, obtaining means)
22 Transmission section (transmission means)
100b Smart phone (first communication apparatus)
200b Family message board server (authentication apparatus)
300c Television (second communication apparatus)
400 Family message board system (authentication system)

1. An authentication apparatus for authenticating a predetermined device via which a user uses a predetermined service,
said authentication apparatus comprising:
registration means for registering a first communication apparatus in such a manner that user identification information capable of uniquely identifying the user is associated with first identification information capable of uniquely identifying the first communication apparatus;
reception means for, in a case where an access to the predetermined service is made via a second communication apparatus after the registration means has registered the first communication apparatus, receiving from the first communication apparatus (i) second identification information capable of uniquely identifying the second communication apparatus, (ii) user identification information, and (iii) first identification information;
determination means for determining whether the user identification information and the first identification information which have been received by the reception means respectively match the user identification information and the first identification information which have been associated with each other by the registration means; and
authentication means for, in a case where the determination means determines that the user identification information and the first identification information which have been received by the reception means respectively match the user identification information and the first identification information which have been associated with each other by the registration means, authenticating the second communication apparatus which is identified by the second identification information received by the reception means, so as to enable the user to use the predetermined service via the second communication apparatus.

2. The authentication apparatus as set forth in claim 1, further comprising presentation means for transmitting an image obtained as a result of encoding of the second identification information to the second communication apparatus so as to cause the second communication apparatus to present the image in such a manner as to be readable by the first communication apparatus,
the reception means receiving from the first communication apparatus (i) the second identification information obtained as a result of decoding of the image, (ii) the user identification information, and (iii) the first identification information.

3. The authentication apparatus as set forth in claim 1, further comprising:
transmission means for transmitting, to the first communication apparatus, presentation information indicative of one or more contents which are provided by the predetermined service and which are to be browsable by the user via the second communication apparatus; and
obtaining means for obtaining, from the first communication apparatus, content identification information capable of uniquely identifying a content selected by the user out of said one or more contents indicated by the presentation information,
in a case where the determination means determines that the user identification information and the first identification information which have been received by the reception means respectively match the user identification information and the first identification information which have been associated with each other by the registration means, the authentication means authenticating the second communication apparatus so as to enable the user to browse, via the second communication apparatus, the content identified by the content identification information obtained by the obtaining means.

4. A communication apparatus being a first communication apparatus which is registered in an authentication apparatus as set forth in claim 1 so as to serve as a device via which a second communication apparatus is able to be authenticated by the authentication apparatus.

5. A communication apparatus being a second communication apparatus which is authenticated by an authentication apparatus as set forth in claim 1 via a first communication apparatus which is registered in the authentication apparatus so as to serve as a device via which the second communication apparatus is able to be authenticated by the authentication apparatus.

6. An authentication system, comprising:
an authentication apparatus as set forth in claim 1;
a first communication apparatus which is registered in the authentication apparatus so as to serve as a device via which a second communication apparatus is able to be authenticated by the authentication apparatus; and
a second communication apparatus which is authenticated by the authentication apparatus via the first communication apparatus.

7. The authentication system as set forth in claim 6, wherein the predetermined service which the user uses via the device is a social networking service.

8. The authentication system as set forth in claim 6, wherein the first communication apparatus is a smart phone.

9. The authentication system as set forth in claim 6, wherein the second communication apparatus is a television.

10. A method for controlling an authentication apparatus for authenticating a predetermined device via which a user uses a predetermined service,
said method comprising the steps of:
(a) registering a first communication apparatus in such a manner that user identification information capable of uniquely identifying the user is associated with first identification information capable of uniquely identifying the first communication apparatus;
(b) in a case where an access to the predetermined service is made via a second communication apparatus after registration of the first communication apparatus in the step (a), receiving from the first communication apparatus (i) second identification information capable of uniquely identifying the second communication apparatus, (ii) user identification information, and (iii) first identification information;
(c) determining whether the user identification information and the first identification information which have been received in the step (b) respectively match the user identification information and the first identification information which have been associated with each other in the step (a); and
(d) in a case where the step (c) determines that the user identification information and the first identification information which have been received in the step (b) respectively match the user identification information and the first identification information which have been associated with each other in the step (a), authenticating the second communication apparatus which is identified by the second identification information received in the step (b), so as to enable the user to use the predetermined service via the second communication apparatus.

11. A computer-readable and non-transitory storage medium in which a control program is stored, the control program being for causing a computer to function as an authentication apparatus for authenticating a predetermined device via which a user uses a predetermined service,
the control program causing the computer to execute the steps of:
(a) registering a first communication apparatus in such a manner that user identification information capable of uniquely identifying the user is associated with first identification information capable of uniquely identifying the first communication apparatus;
(b) in a case where an access to the predetermined service is made via a second communication apparatus after registration of the first communication apparatus in the step (a), receiving from the first communication apparatus (i) second identification information capable of uniquely identifying the second communication apparatus, (ii) user identification information, and (iii) first identification information;
(c) determining whether the user identification information and the first identification information which have been received in the step (b) respectively match the user identification information and the first identification information which have been associated with each other in the step (a); and
(d) in a case where the step (c) determines that the user identification information and the first identification information which have been received in the step (b) respectively match the user identification information and the first identification information which have been associated with each other in the step (a), authenticating the second communication apparatus which is identified by the second identification information received in the step (b), so as to enable the user to use the predetermined service via the second communication apparatus.
